(19) United States
(12) Patent Application Publication
(10) Pub. No.: US 2024/0049750 A1
(43) Pub. Date: Feb. 15, 2024

(54) FOAMED, ELASTIC, PROTEIN-BASED PRODUCT, METHOD FOR PRODUCING SUCH PRODUCTS, MORE PARTICULARLY PLANT PROTEIN- AND PLANT FIBRE-BASED EXTRUDED MEAT ANALOGUES, DEVICE FOR CARRYING OUT SUCH A METHOD AND USE OF THE PRODUCT FOR PRODUCING PLANT PROTEIN-BASED MEAT ANALOGUES

(71) Applicant: ETH ZÜRICH, Zurich (CH)

(72) Inventors: Erich WINDHAB, Hemishofen (CH); Joel ZINK, Zurich (CH); Cédric SAX, Zurich (CH)

(73) Assignee: ETH ZÜRICH, Zurich (CH)

(21) Appl. No.: 18/259,255

(22) PCT Filed: Dec. 6, 2021
(86) PCT No.: PCT/EP2021/000153

§ 371 Date: Jun. 23, 2023

(30) Foreign Application Priority Data
Dec. 23, 2020 (DE) 10 2020 007 887.7
Dec. 24, 2020 (DE) 10 2020 007 892.3

(51) Int. Cl. A23J 3/26; A23J 3/22; A23J 3/24; A23J 3/14

(52) U.S. Cl. CPC A23J 3/26; A23J 3/227; A23J 3/24; A23J 3/14

(57) ABSTRACT

The invention relates to a product having a foam structure with a set ratio of gas pores open to the product surface and closed to the product surface. The invention also relates to a method with four embodiments according to the invention for the defined mechanical opening of closed foam pores. Furthermore, the invention relates to a device having four embodiments according to the invention for the defined mechanical opening of closed foam pores. The invention also relates to the use of products designed according to the invention as meat analogs or plant protein-based textured multiphase foods, more particularly vegetable or fruit composites. Particular advantages of the invention relate to the targeted influencing of the deformation and texture properties of foamed products and their accessibility from the outside for quick and easy filling of the open pores with fluid systems which introduce additional functionalities into the product.

### FIELD

The invention relates to a foamed, resilient, protein-based product.

Furthermore, the invention relates to a method for producing such a product with a degree of pore opening set in a defined manner.

The invention also relates to a device for carrying out the method according to the invention.

Finally, the invention relates to the use of the product according to the invention as the main component for producing meat analogs based on plant proteins.

### Prior Art

Viscous masses can be foamed in extruders, in which gas is metered in under atmospheric or excess pressure, mixed/dispersed and/or partially or fully dissolved under excess pressure, is then released again by pressure release and remains partially or fully incorporated in the viscous mass to form a foam /1,2/.

Another known possibility is the addition of foaming agents, which form a gas as a result of a chemical/physicochemical and/or thermal reaction, which is also partly or fully incorporated into the viscous mass with the aid of mixing/dispersing processes to form a foam. Corresponding viscous masses can be of a synthetic and/or biological nature or also consist of mixtures thereof and can be the basis or component of products in the food, cosmetics, pharmaceuticals, building materials or plastics industries. In extruders, viscous masses foamed in this way are conveyed by the extruder screws and pressed through an extruder nozzle. As a result of the constriction of the flow cross-section at the transition from the extruder housing to the extruder nozzle, a static pressure build-up occurs, which in the nozzle is reduced again to atmospheric pressure at the extruder nozzle outlet with the nozzle cross-section being kept more or less constant via the flow shear stresses prevailing there due to wall friction and inner fluid friction. The pressure build-up in the nozzle inlet zone (before entry into the nozzle) compresses the gas trapped in the foam bubbles and thus reduces the size of the foam bubbles, the pressure reduction in the extruder nozzle down to the outlet atmospheric pressure allows the gas in the foam bubbles to expand again and thus enlarges the foam bubbles. Bigger gas bubbles can be deformed in the nozzle flow compared to smaller gas bubbles at lower flow stresses and, if a critical stress is exceeded, they can be broken up and thus converted into smaller bubbles.

As a rule, the aim is for a material strand with a defined shape to emerge from the extruder nozzle, since the product is also typically shaped by means of the extruder nozzle. The dimensional accuracy of such products is often also an important quality measure. This is achieved, among other things, by implementing a uniform laminar flow in the nozzle, which corresponds to a planar stratified flow. If a foamed fluid system is moved in such a nozzle flow, there is increased shearing of the fluid system at the nozzle wall due to the typical parabolic flow profile, whereas no shearing occurs in the middle of the nozzle channel. Cross-mixing of the fluid system flowing in this way does not occur (parallel stratified flow) provided the nozzle channel does not have any flow obstacles. The maximum wall shear rate present in the fluid layer in contact with the wall (=speed of the fluid film under consideration close to the wall on its side facing the center of the nozzle channel divided by the fluid film thickness) usually causes the formation of a boundary layer close to the wall. If the fluid system contains disperse components, these disperse components are set in rotation as a result of the wall shear rate effective in the fluid layer under consideration close to the wall, and experience a dynamic buoyancy force (lift force), which causes the disperse components to separate away from the wall towards the middle of the nozzle channel. This applies in principle to solid particles /3/ but also to gas bubbles /4/ and leads to a depletion of the fluid layer close to the wall of such disperse components.

The “High Moisture Extrusion Cooking (HMEC)” process is preferably used for the extrusion of meat analogs based on plant proteins. This process relates to extrusion at a high temperature (up to approx. 170° C.) and high static pressures (up to approx. 100 bar) with product water contents of up to approx. 70% by weight. In an aqueous protein melt produced under these conditions, protein denaturation occurs in the form of protein fibrils that form, which are oriented in the direction of flow in the extruder nozzle inlet flow as a result of the elongational flow components that are effective there and are solidified in this oriented structural state by subsequent cooling (to approx. 60° C.) in a long (≥approx. 1 m) extruder cooling nozzle. In the case of typically laminar nozzle flow, the cooled product exits the extruder nozzle as a smooth strand. The oriented protein fibrils give the product a meaty, fibrous texture /5/. As a result of the slow cooling of the product in the extruder nozzle, a sudden release of water vapor is suppressed and structure formation is therefore not interfered with.

The prior art with regard to HMEC extrusion methods for the production of plant protein-based meat analogs is comprehensively described, for example, in patent specifications U.S. Pat. No. 6,635,301 B1, WO2016/150834 A1, EP1182937 A4, WO2009075135, US20050003071 A1, WO2016150834 A1 and U.S. Pat. No. 10,716,319 B2.

U.S. Pat. No. 10,716,319 B2 (Method of making a structured protein composition) is considered from a technological point of view as the closest description (closest state of the art) to the technology according to the invention described in this patent application: (Translated abstract from U.S. Pat. No. 10,716,319 B2): “The fibrous composition obtained in the extruder leaves the extruder at a temperature of the composition that is higher than the applicable boiling temperature of water (e. g. 100° C. at atmospheric pressure or lower if a vacuum port is used). It is believed that this leads to expansion and subsequent collapse of the textured product. It is further believed that the expansion/collapse treatment interferes with the fiber orientation and thus leads to the creation of a more random orientation of the formed fibers. In addition, it is assumed that air pockets (on a micro and macro scale) are formed in the textured product. To fine-tune mouthfeel (bite), tenderness and juiciness, after the texturing process, the extruded product can be hydrated in an aqueous liquid at elevated temperatures, i.e. between 40 and 150° C., to a final moisture content of 50 to 95%. Cut tests are most commonly used to measure the tenderness of the extrudates, for example using a Warner Bratzler shear blade//or a Kramer shear cell//. The product of the invention has a heterogeneous structure and a relatively large free volume. This contributes to its relatively high water absorption capacity. This is beneficial because the absorption of aqueous liquids makes it easier to add desired flavor components and allows the product to be varied in terms of juiciness and bite. An infusion into the extrudate according to the invention takes place into the moist product obtained by extrusion. In contrast to the background art, the extrudate of the present invention does not require drying and rehydration. It remains substantially moist and is then further filled with water or other aqueous composition by infusion. The extrudate preferably has a water content of 55% to 70% by weight. The structured plant protein composition resulting from infusion with an aqueous liquid preferably has a water content of 70% to 90% by weight. Surprisingly, the above-mentioned infusion can be enhanced (i.e. drain more quickly and/or allow for incorporation of more water) by an aqueous liquid if the extrudate has been frozen first (and then thawed prior to infusion). Preferably, the freezing temperature is below −5° C. and −15° C.”

The microfoaming of highly viscous and viscoelastic, dough-like, protein and non-protein-based masses by means of extrusion methods is described in WO 2017/081271 A1.

The state of knowledge on food foam systems is described, for example, in Peter J. Hailing & Pieter Walstra (1981) Protein-stabilized foams and emulsions, C R C Critical Reviews in Food Science and Nutrition, 15:2, 155203, DQI: 10.1080/1040839810952 7315 and in Ashley J. Wilson (1989) Foams: Physics, Chemistry and Structure; Springer Verlag London, ISBN 978-1-4471-3809-9.

The production of open-pore foams is known from the plastics/foams industry (N. Mills (2007); Polymer Foams Handbook; Hardcover ISBN: 9780750680 691; Imprint: Butterworth-Heinemann).

Conventional extrusion methods, in particular cooking-extrusion methods in the field of food, building materials and animal feed applications, produce pores that are only reproducible within wide limits and are not reproducible, due to the sudden evaporation of water/solvent at the extruder nozzle outlet. The product (extrudate) experiences the formation of a foam-like structure, which is obtained by the sudden evaporation of the water as a result of the pressure drop.

In more recent extrusion/cooking extrusion methods, a foamed product can result in a product with a more controlled foam structure by means of gas metering and gas dispersion or gas dissolution and renucleation of gas bubbles. However, such products typically have closed pores and, as they flow through the extruder nozzle, form a skin layer largely free of foam bubbles and pores as a result of the maximum shear near the wall.

For foam extrusion applications, it is essential to control the foam pore structure in order to adjust the product properties in such a way that the ratio of closed and open pores can be adjusted.

In certain applications, e. g. in instant products, open pores enable a desired rapid absorption of liquid by capillary forces, closed pores are desirable when setting the lowest possible product density, obtaining a foamy/creamy mouthfeel (food) or reducing the absorption rate of fluid (foam bubbles as mass transport barriers).

For a certain range of products from different areas of application, the adjustability of the ratio of closed to open pores is essential for the development of certain quality features. Typical examples are fish feed pellets which, in terms of their rate of sinking or their swimming behavior, certain species of fish, which typically take up their feed from the bottom of the water body (from floating at a certain water depth or swimming from the surface).

So far, there is no industrially relevant solution for food products with a high content of bound water, such as plant protein-based meat analogs, which have up to >60% intermolecular water formation, in order to optimize such products in terms of their consistency and thus in a texture-sensory sense on the one hand through defined adjustable (i) microfoam formation and (ii) ratio of open to closed pores, and on the other hand, to implement an adjustable additional, especially production-relevant fast (in the range of seconds) fluid absorption capacity, to optimize, e.g., juiciness and certain further processing properties in, e.g., frying processes/grilling processes as well as taste/flavor and nutritional functionalities.

It is known from KR 1020200140499 A to produce a foam structure, with random gas inclusions being produced. It is also proposed to influence a change in the gas inclusion layers and their shape by means of empirical formulation changes, which, however, is again not possible in a targeted manner. A stochastic porous structure is created at the extruder nozzle outlet, which can hardly be influenced in terms of process engineering, since it is an uncontrolled rapid expansion. Provided long-chain resilient gluten molecules are present, such steam expansion is counteracted to a greater extent and a less expanded product is thus obtained. This technically uncontrolled production of porous extrudate products is transferred to meat analogs containing gluten.

It is previously known from 2020/0060310 A1 to produce a porous structure by “puffing”. This is understood to mean a sudden expansion which cannot be adequately controlled with regard to the resulting porosity and certainly not with regard to a defined degree of pore opening.

### Objects

The invention is initially based on the object of creating a foamed product with a high fraction of bound water, in the case of extruded meat analogs based on a concentrated plant protein melt with >30% by weight plant protein fraction and >5% by weight plant fiber fraction and a gas volume fraction in the end product of >10% by volume, the gas volume being present in the form of pores/bubbles which, in a fraction that can be set, should be present as a pores that are open towards the product surface, to ensure an accelerated further liquid absorption, with sensory and/or nutritionally relevant components contained in this liquid, in the product, for example.

Furthermore, the invention is based on the object of providing a method with which such products can be produced.

In addition, the invention is based on the object of providing a corresponding device that enables said method.

Finally, there is the object of using such a product, for example for the production of plant protein-based meat analogs/meat alternatives.

### Achieving the Object Relating to a Product

This object is achieved by the features of claim 1.

### Some Advantages

The new, foamed products according to the invention allow, via the setting of the degree of foam pore opening, a coupled setting of certain sensory and nutritional attributes as “intrinsic” properties of these products, which could not be achieved for conventional products of this category or only to a small extent through additional products (sauces, toppings, etc.). In the case of foamed, plant protein-based meat analogs, the (a) sensory quality attributes relevant to the consumer: tenderness, juiciness, crispiness, meat taste/aroma, (b) nutritional functionalities (e.g. by introducing bioavailable iron and B vitamins) and (c) convenience properties are made available by enabling or improvement in cooking, roasting and grilling ability in a tunable manner.

The formation of a foam structure in a highly viscous to semi-solid product significantly influences its mechanical behavior in the direction of a more easily deformable/softer material. In the case of such products in the food sector, such as represented by extruded, foamed plant protein-based meat analogs, one would postulate a less compact, hard or “more tender” consistency as a result of foaming. In case of (A) a closed-pore foam system, the compressibility of the gas enclosed in the pores contributes to the deformation behavior of the foam product. When a deforming force is removed, the resilient reverse deformation is supported by the reverse expansion of the gas enclosed in the pores, and even dominated with a high fraction of gas volume. In the case of (B) open-pore foams, the gas in the pores can escape more or less quickly when the foam matrix deforms, depending on the pore size. The deformation behavior of the matrix material forming the foam lamellae thus dominates the macroscopic deformation behavior of the foam product.

In the case of foamed foods, which are subjected to significant deformation by biting and chewing when consumed, a closed foam pore structure (A) enhances the sensory texture impressions of (i) tenderness but also (ii) gumminess in the case of solid structures of the foam lamellae surrounding gas bubbles and (iii) creaminess in the case of fluid foam lamellae properties.

Open-pored, spongy foam structures (B) allow the sensory textural attributes (iv) crunchiness but also (v) brittleness to come to the fore with firm foam lamellar properties. The case of fluid foam lamellar properties is irrelevant for open-pored product systems, since deliquescence of the matrix material leads to a foam with closed pores.

In the case of defined foamed matrices of plant protein-based meat analogs, which have a fixed structure of the foam lamellae surrounding the gas bubbles, consumer wishes/consumer ideas address fibrousness in particular, combined with tenderness and other important attributes, juiciness and crunchiness/bite/crispness as sensory texture attributes, often also in the context of certain preparation methods (e.g. cooking, roasting, grilling).

In the case of such foamed meat analog products with at least partially open pores, their sensory, nutritional and preparation convenience properties can be significantly expanded in that the pores of the foamed base product are partially or fully filled with functional or functionalized fluids, wherein such fluids after pore filling can also solidify. By means of such “fluid fillings” of the open-pored meat analogs, specific taste and aroma-related sensory and/or nutritional product properties and, if necessary, the product stability via preserving components can be optimized.

The filling of open pores can occur, for example, by capillary forces which, given coordinated wetting properties of the filling fluid phase, allow the fluid to be sucked in as a result of the formation of a capillary negative pressure. Since such capillary forces are inversely proportional to the pore diameter, small pore diameters in the range ≤approx. 500 microns are preferred.

The subject matter of the invention is based on a HMEC technology as described above for the preferred production of plant protein-based meat analogs, with this technology being significantly supplemented by combination with a micro-foaming process, which occurs in the extruder and in a comparable manner, was described in /2/ in relation to the production of foamed baked goods. In this case, a defined dose of gas (e.g. N₂, CO₂) is dissolved first in the aqueous protein melt in the extruder under the high pressure set there and then released again under pressure reduction in the extruder cooling nozzle. In the process, gas bubbles are nucleated at the beginning of the extruder nozzle and enlarged as the nozzle flow progresses with progressive pressure release, thus forming a foam structure.

Furthermore, the description of the present subject matter of the invention is based on this foaming technology and its transferability to the production of meat analogs foamed in this way, produced by means of HMEC technology. The product-related focus of the subject matter of the invention described below is on the plant protein-based (foamed) meat analogs, which make available innovative adjustment options for sensory and nutritional product characteristics of significant consumer relevance through the adjustability of the ratio of closed pores/pore channels to pores/pore channels open towards the product surface.

The cooling of the product flow from the HMEC extruder close to the wall at the entry to the extruder nozzle, which begins during the production of meat analogs, allows to form fewer foam bubbles near the nozzle wall under the high pressure still prevailing there and the already noticeably lower temperature near the nozzle wall (of typically approx. 140-160° C. to approx. 90° C.) as a result of the improved gas solubility at lower temperatures.

The (i) high shear of the cooling, foamed protein melt near the nozzle wall supports, in addition to the mentioned effect of (ii) improved gas solubility, a (iii) gas bubble depletion through flow effects (dynamic buoyancy forces) in the nozzle wall zone. The “skin layer” of the extruded, foamed meat-analog strand, which is partially or fully depleted of gas bubbles, shields inner foam pores from the environment. Since, as a result of the typically slow product cooling in the long cooled extruder nozzles used in meat analog HMEC extrusion, no more significant residual pressure release occurs at the nozzle outlet, a product skin layer formed as described remains closed. For the micro-foamed products this means the presence of a closed foam pore system.

For a number of applications or final product formats, it is advantageous to create open, spongy pore systems that are able to absorb liquids through outwardly open pores in the porous (spongy) product matrix. Fluids absorbed in such a form can interact with the matrix structure, retain fluid character or solidify or partially solidify under the framework conditions to be set (e.g. temperature). For example, food systems equipped with such open-pored porosity could absorb liquids that impart juiciness to the food in question. For building materials with a corresponding pore structure, suitable fluid systems for impregnation could result in improved resistance to mold/fungus infestation or harmful insects. For applications in wound healing, covering material with a correspondingly open-pored, porous structure can be impregnated with fluids for disinfection or fluid components that promote wound healing.

Against this background, there is great application-specific interest in adjusting the pore structure of foamed product systems in extrusion methods in a targeted manner.

Accordingly, the subject matter of the invention addresses a technology for adjusting the ratio of closed pores/bubbles to open pores/pore channels that are open towards the product surface. In principle, this can also be achieved mechanically through the connection of originally closed foam bubbles/pores, provided that these foam bubbles/pores can be made to coalescence or form connecting channels between them and to the product surface without significant loss of total gas volume fraction and fine pores.

According to the invention, the pore volume ratio E=ε_{OP}/ε (ε_{OP}=porosity of the open pores; ε=total porosity), adjustable by means of various specific measures, is achieve in their individual or coupled application. These pore opening technologies POTᵢ according to the invention can be found in Table 1 and are described in detail below.

| | Short | | Setting |
|---|---|---|---|
| No. | designation | Description | exactness |
| POT1 | Flash- | Pores are opened (POT-1.1) towards the | o |
| | Opening | outside by more residual pressure release | |
| | (FOP) | and, if necessary, additional (POT-1.2) | |
| | | partial vacuum post-treatment | |
| POT2 | Cut- | Extrusion product strand is cut or skin layers | + |
| | Opening | are “peeled off” | |
| | (COP) | | |
| POT3 | Penetration | Multiple needle penetration at the nozzle | ++ |
| | Opening | outlet opens access and connection channels | |
| | (POP) | to or between the inner closed pores | |
| POT4 | Forced | An adjustable aperture making specific use | + |
| | Secondary | of the flow properties of the product while it | |
| | Mixing- | is cooled down in the extruder nozzle | |
| | Flow | generates so-called secondary flow mixing | |
| | Opening | effects which enable inner product areas to | |
| | (Mix- | be turned to the outside and pore | |
| | Opening, | channels/gaps to be opened or generated with | |
| | MOP) | an adjustable characteristics. Viscoelastic | |
| | | fluids, such as protein melts enable such flow | |
| | | effects to be produced to a greater effect and | |
| | | in an adjustable manner. | |
| POT5 | Slow | Ice crystals penetrate foam lamellae between | |
| | Freeze- | closed foam pores and thus form open pore | |
| | Opening | channels | |
| | (FOP) | | |

POT-1:

A slit-nozzle aperture (VSDA) according to the invention, the gap width of which can be adjusted, is arranged shortly before the end or at the end of an extruder slit nozzle which may be shortened, and constricted to a position which allows adjusting the static pressure before entry into the constricted slit gap to a value of ≥approx. 1.5-2 bar of the static pressure prevailing after exiting the slit gap, which is typically atmospheric pressure. With this procedure according to the invention, the strand of extrudate is not cut off directly at the nozzle exit, but only from a length of 5-10 cm. This means that the shorter length distance between the middle of the extrusion strand and its surface compared to the extruded product strand length up to the strand cutting device is approx. ≤½-⅙. According to the invention, this brings about a preferred gas pressure release in the product cross-sectional direction and thus towards the product surface. This is due to the significantly greater pressure gradient implemented in this direction compared to the pressure gradient prevailing in the strand length direction. The characteristics of the pore channels formed in the direction of pressure release and their opening outwards towards the surface of the extruded strand is significantly determined by the rheological properties of the extruded product at the time it emerges from the extruder nozzle. Lower viscosity (or elasticity) allows a more pronounced material deformation under the effect of the gradient for pressure release and, as a result, a more pronounced formation of pore channels.

The design of the geometry of the adjustable slit nozzle device (VSDA) according to the invention enables a different geometric shaping of the profile of the flow cross section in the direction of flow. According to the invention, the constriction is preferably sudden (approx. 90°), which pushes the formation of a secondary flow of the extrusion strand fluid in the zone of the widening of the flow channel cross section. In this follow-on secondary flow zone, the static pressure is significantly lowered and, on the other hand, a roller-shaped secondary flow is generated, which causes the strand fluid to be mixed transversely to its direction of flow in the vertical direction of the slit nozzle channel. The “inside-out turn” of the extrusion strand material depends on the intensity of the secondary flow and the rotation frequency thereof. Since the strand material is located just before the nozzle exit or directly at it, there is no possibility of a renewed formation of a closed skin layer on the product strand, which would lead to renewed pore closure. This results in the formation of persistent pores/pore channels that are open towards the surface of the extrusion strand.

The products according to the invention, produced by the method according to the invention using the device according to the invention, make available novel extrusion products with a defined foam structure. These products form a practical basis for new product developments:
(a) with adjusted volume ratio of open and closed pores (degree of pore opening, POG),
(b) without skin/edge layer formation when flowing through the extruder nozzle
(c) with adjustable texture properties (tenderness, crispiness, juiciness)
(d) with extended possibilities of taste/aroma/active ingredient optimization through fluid systems incorporated into the open pores, which contain corresponding taste, aroma or active ingredient components that do not go through the extrusion process, thus avoiding their reduction in functionality and accelerating their release upon application (consumption and digestion of food, intake of pharmaceutical products) via the open pore channels.
(e) with expanded possibilities for “instant product” production, which allow accelerated wetting and dispersion in liquids

### FURTHER INVENTIVE CONFIGURATIONS

Further inventive configurations are described in claims 2 to 10.

Claims 2 to 5 emphasize the important role of the protein fraction and the set denatured, possibly anisotropically formed protein structure, since the meat analog products that are preferably considered owe their meat-like texture properties to a significant extent to the denatured, fibrillar protein structures.

Claim 2 describes a product in which the protein fraction is 10-95% by weight in its dry matter, while claim 3 describes a product in which the protein fraction is 0-100% by weight plant protein.

The product in claim 4 is characterized in that the protein in the product is present in partially to fully denatured form and has a fibrillar structure, while the product according to claim 5 is characterized in that the denatured form has an oriented fibrillar structure.

Claims 6 to 8 take into account ingredients and their quantities which are of particular importance for the setting of the sensory and nutritional of corresponding vegan meat analogs.

For this purpose, the product according to claim 6 includes a plant fiber fraction of 0.5-20% by weight, based on the dry matter.

In claim 7 a product is described in which the product includes a fraction of fats or oils of 0.1-15% by weight, based on the dry matter, while the product in claim 8 is characterized in that it includes a fraction of flavoring and/or coloring components and/or components that increase the nutritional value in addition to the plant fiber fraction, of 0.1-5% by weight, based on the dry matter.

Claims 9 and 10 address a surprisingly found special feature of the foamed products according to the invention with an open pore fraction, which represents their volume, shape, structure and texture-related reconstituting ability after almost complete drying. The influence of the degree of pore opening has a significant influence on the acceleration of water transport from the moist product and into the dry product both during drying and during reconstitution.

For this purpose, claim 9 proposes a product which, after drying to a residual water content of ≤5% by weight and moisture-controlled storage for several months with no spoilage under room temperature conditions, upon contacting with water or a water-containing fluid system reconstitutes to its original volume and texture without loss of dry matter.

Claim 10 describes a product in this regard which, after drying to a residual water content of ≤5% by weight and moisture-controlled storage for several months with no spoilage under room temperature conditions, upon contacting with water or a water-containing fluid system reconstitutes to its original volume and texture.

### Achieving the Object Relating to the Method

This object is achieved by claim 11, which is characterized in that the method implements the opening of gas pores or gas bubbles enclosed in the foamed product towards the product surface in an adjustable manner, based on an extrusion method of the “high moisture extrusion cooking” type (High Moisture Extrusion Cooking, HMEC) with gas entry, temporary gas dissolution and controlled gas bubble nucleation as well as foam formation, and five method variants for pore opening being employed: (a) opening by rapid ambient pressure drop (Flash-Opening, FOP), (b) opening by splitting or peeling the product (Cut-Opening, COP), (c) opening by multiple needle penetration (Penetration-Opening, POP), (d) opening by forced secondary mixed flow (Mix-Opening, MOP) and (e) opening by freeze structuring (Freeze-Opening, FOP), individually or in combination, whereby the opening of gas pores or gas bubbles enclosed in the foamed product towards the product surface is implemented in an adjustable manner.

### Some Advantages

The method according to the invention and its configurations can be coupled directly to the HMEC extrusion process and the extrusion parameters to be set for structuring the protein matrix for the pore opening can be directly transferred. Thus, for the mechanism of (a) pore opening by rapid ambient pressure drop (Flash-Opening, FOP), the static pressure built up in the extruder can be maintained up to the end of the nozzle to such an extent that a sufficiently rapid and efficient residual pressure release can be implemented towards the pore opening. In the case of the mechanisms (b) pore opening by splitting or peeling of the product (CUT-Opening, COP) and (c) pore opening by multiple needle penetration (Penetration-Opening, POP), the movement or kinetic energy of the extrudate strand at the end of the nozzle is used for cutting/peeling or for needle penetration. To activate the (d) pore-opening mechanism through forced secondary mixed flow (Mix-Opening, MOP), part of the kinetic flow energy of the extrudate strand is utilized to generate a roller-shaped secondary flow that also periodically oscillates for viscoelastic masses, which causes mixing transverse to the flow in the vertical direction of the extruder slot nozzle, which elongates closed foam pores as a result, moves them towards the surface of the strand and “tears open” the surface structure with an intensity that can be adjusted, in such a way that a part of the correspondingly treated pores, which can also be adjusted, is opened towards the product surface. The adjustability of the degree of pore opening is based on the adjustability of the intensity of the mixing secondary flow, which in turn can be adjusted within wide limits by adjusting a local slit nozzle height reduction and the transport speed of the extrudate strand. The mechanism (e) for pore opening by freeze structuring is used according to the invention on foam structures in order to penetrate primarily large ice crystals for penetrating material partitions between closed pores at a preferably slow freezing rate and thus convert them into open pores. The high-water content (up to ≤60% by weight) of the preferably considered plant protein-based meat analogs helps to support the formation of ice crystals.

### Further Inventive Configurations

Further inventive configurations are described in claims 12 to 25.

According to claims 12 to 21, the pore-opening methods are detailed in their technical implementation by means of mechanisms (a)-(e), (a) mobilizes compressive forces to break open pore boundaries outwards towards the product surface; (b) uses targeted incisions to expose the pore openings; (c) creates connecting channels between the closed product pores and outwards towards the product surface through needle penetration; (d) refers to the generation of secondary flows in the extruder cooling nozzle in order to break up largely closed product skin layers created in the laminar slit nozzle flow by cross-mixing in the height coordinate direction of the nozzle channel and create additional superficial transverse channels/cross grooves. For the protein-rich, meat-analogous product systems, which are primarily addressed, an additional flow-dynamic feature of viscoelastic fluid systems can be advantageously used according to the invention. The so-called elastic turbulence effect (in literature relating to plastics processing also referred to as “melt fracture phenomenon”) arises as a result of the elastic deformation energy storage in the converging inlet flow of a slit-nozzle aperture (VSDA) device designed according to the invention and arranged in a defined manner in the nozzle channel and adjustable with regard to slit channel constriction.

In the diverging outlet flow after the constriction, the previously stored elastic tensile stresses partially relax again through elastic reverse deformation of the viscoelastic fluid (e.g. a protein melt corresponding to HMEC extruded meat analogs). Small flow asymmetries or the stochastic variance of the elastic deformation cause the formation of a periodic, sinusoidally oscillating, roller-like flow disturbance. As was surprisingly shown on the basis of rheological laboratory measurements for a large number of polymer melts, the secondary flow phenomenon described above develops at a ratio of the first normal stress difference N₁ to the shear stress T from a value of N₁/τ≥1.5-2 and is particularly effective in a range N₁/τ≈4-5 in order to efficiently utilize the described inventive effect of the sinusoidal oscillating secondary mixed flow (OSMS) in the follow-on of a local slit nozzle gap constriction for cross mixing in the extruder nozzle for the pore opening towards the product surface. The OSMS can thus be set in the range 2≤τ_{W}/N₁<5 in its method-relevant intensity according to the invention, Tw and N₁ can be measured both in rheometric laboratory measurements using a cone-plate shear gap and in high-pressure capillary rheometric measurements. According to the invention, the latter are also transferred directly to in-line measurements in the extruder slit nozzle. According to the invention, this is done by means of static pressure profile measurements in the nozzle channel before and after the local slit nozzle height reduction or alternatively also in the extruder-side nozzle entry zone. More simplified according to the invention, the intensity of the OSMS is measured via the amplitude of the static pressure fluctuation in the slit nozzle channel before or after the local slit nozzle height reduction. The setting of a maximum elastic-turbulent OSMS via an adjustable aperture according to the invention for local slit nozzle height reduction is possibly limited by the fact that an excessively fragmented product strand at the nozzle outlet is to be avoided. This is achieved in that the adjustable slit nozzle aperture (VSDA) device according to the invention is installed in the extruder cooling nozzle, typically in the first two thirds of its length. In this way, the elastically-turbulently mixed product strand is partially evened out again in a defined manner in the laminar layer flow that is restored after the aperture and crack formations in the structure are gradually healed again, if desired. In order to avoid the renewed formation of a skin layer of the product strand with associated pore closure towards the product surface, the degree of OSMS adjustable via the VSDA as described and the length of the extruder nozzle in the aperture follow-on are adjusted or calibrated specifically for the material system according to the invention.

Claims 22 and 23 refer to the possibility of drying the products after the pore opening has taken place according to any one or a combination of methods (a)-(e) in order to achieve an extended shelf life at ambient temperature storage in this way. According to the invention, the opening of the pores advantageously accelerates the transport of water during drying and also during reconstitution.

According to claims 24 and 25, the basic conditions for the accuracy of setting the degree of pore opening and the underlying total gas pore volume in the product, which should have or should be furnished with an open connection to the product surface, are specified. The resulting bandwidth of (i) a minimum of 10% by volume total gas fraction (in pore form) of which 5% is open, up to (ii) a maximum of 80% by volume total gas fraction (in pore form) of which 90% is open, is relevant for foamed meat analogs, for example, in order to achieve, e. g., easy penetration with intense flavoring substances in fluid form in case (i), and to penetrate homogenously, e. g., 72% of the product volume with a consistency/texture imparting fluid phase, which optionally solidifies after the pore filling in case (ii). In the latter case, when applied to meat analogs, a scaffolding protein structure was obtained with e. g. vegan pie/sausage filling. In the range between (i) and (ii), “marbled” product structures with an adapted fat/gel insert can be implemented in order to further adjust typical meat/fat/connective tissue/gel structures and associated sensorily preferred texture properties.

According to claim 25, the gas-filled volume fraction is limited to 80% by volume, since the pore opening mechanisms according to the invention, which are related to more solid foam products, can no longer be transferred sufficiently non-destructively for the overall product if the foams are too fragile.

### Achieving the Object Relating to the Device

This object is achieved by claim 26, which is characterized in that the extrusion nozzle has a downstream cutting device and a downstream conveyor belt partially perforated in the middle in sections of the cooling nozzle of an HMEC foaming extruder, and the conveyor belt with the cut-off part of the product lying on top is guided between two vacuumizing half-shells which, pressing against each other from above and below, enclose the conveyor belt and the product in a sealed manner, and wherein these vacuumizing half-shells are connected to a vacuum storage tank via a vacuum line provided with a quick opening valve and which vacuum storage tank is connected to a vacuum pump, for the sudden application of a partial vacuum to the foamed, extruded product.

The pore opening mechanisms utilize mechanical, fluid mechanical or thermodynamic principles to open closed pores towards the product surface by means of a:
(a) device variant for setting a rapid drop in ambient pressure (Flash-Opening, FOP),
(b) device variant for splitting or peeling the product (CUT-Opening, COP) in the exit area of the extruder cooling nozzle,
(c) device variant for multiple needle penetration (Penetration-Opening, POP) directly after the partially cooled product exits the extruder cooling nozzle
(d) device variant for generating a secondary mixed flow (Mix-Opening, MOP) in the extruder cooling nozzle.
(e) device variant for generating large ice crystals for foam lamella penetration by means of freeze structuring (Freeze-Opening, FOP) in a post-treatment for quench cooling after extruder cooling nozzle exit, which can be used in individual or coupled application.

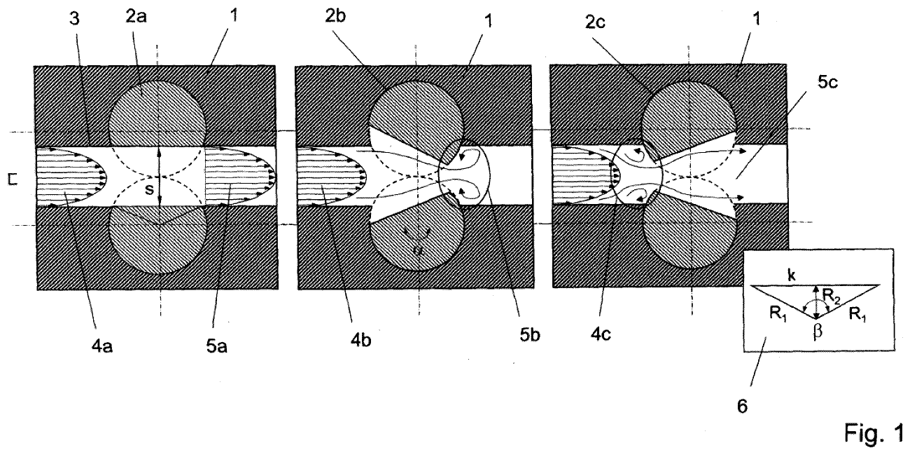

The core element of the devices for activating the pore opening mechanisms according to (a) and (d) is an adjustable slit-nozzle aperture (VSDA). Its free cross-sectional area for the passage of the extrudate corresponds exactly to the dimensions of the free cross-section of the extruder slit nozzle when it is 100% open. In the case of a flat, rectangular extruder nozzle slit channel a truncated, rotatably slide-mounted metal cylinder (2) is sealingly embedded in the aperture housing (1) in each case in the upper and lower wall delimiting the flow slit of the aperture device over the entire slit width, at a right angle to the direction of flow. The cutting surfaces of these cylinders are flush with the flow channel wall (3) when the aperture is fully open. The metal cylinders (2) can be set rotatably from outside the aperture housing (1) by hand or by means of a servomotor in a controlled or regulated manner, so that a constriction of the aperture occurs on one side or symmetrically to the longitudinal axis of the nozzle, which corresponds to the maximum degree of closure of the slit channel at a twist angle of 90° (for further details, see the description of the figures, FIG. 1).

Activation of the pore-opening mechanism d) to generate a secondary mixed flow (Mix-Opening, MOP) in the extruder cooling nozzle can occur solely by means of the VDSA device. In case (d), said device is integrated into the nozzle at a position between 10-95% of the nozzle length measured from the nozzle exit end. In the case of a severely disintegrated extrudate structure, this ensures that said disintegrated extrudate structure reintegrates to one part on the remaining stretch of the nozzle after the passage through the aperture, thus preventing the extrudate strand from disintegrating at the nozzle exit.

To utilize the pore opening mechanism (a) as a result of sudden residual pressure release, the VDSA device is integrated into the nozzle in a position between 0-10% of the nozzle length measured from the nozzle outlet end. This ensures that the sudden release of the static residual pressure and thus the opening of the pores towards the extrudate surface only occurs shortly before the nozzle exit or directly at the nozzle exit.

If the extrudate is additionally suddenly subjected to a partial vacuum to open the pores, cut off extrudate parts are post-treated in a separate, quasi-continuously operating vacuum device directly after the nozzle outlet. This additional treatment variant is preferably carried out for softer extrudates which, in the case of protein-based meat analogs, have a higher nozzle outlet temperature or a higher water content.

When using the pore opening variant (c) for multiple needle penetration (Penetration-Opening, POP) directly after the exit of the partially cooled product from the extruder cooling nozzle, in the embodiment of the device preferred according to the invention, at the extruder nozzle outlet there are two counter-rotating hollow needle or barbed felting needle rollers attached in such a way that the needles penetrating the extrudate from both sides engage with each other and the rotation of the needle rollers preferably occurs without an auxiliary drive, solely by the feed of the extrudate through the gap between the two needle rollers (for further details see description of the figures, FIG. 5).

When using the pore opening variant (c) by means of splitting or peeling the product (CUT-Opening, COP) in the exit area of the extruder cooling nozzle, a cutter/paring knife arrangement is arranged shortly before exit or directly at the exit of the extrudate strand from the extruder nozzle. The extrudate strand feed is thus used to implement the cutting forces. Internal foam pores are thus opened towards the newly created product surface. This is indicated in particular when a “skin layer” with fewer foam pores has formed in the nozzle flow.

### Some Advantages

With the exception of the additional vacuum application to activate the pore opening mechanism (a) to set a rapid drop in ambient pressure (Flash-Opening, FOP) and freeze structuring to activate the pore opening mechanism (e) to penetrate the pore wall by means of ice crystals (Freeze-Opening, FOP) all other devices have a simple structure and are arranged directly in or coupled to the extruder nozzle. This results in the particular advantage of the direct linkability of these mechanisms and the associated device variants. All of these devices are insensitive to contamination, mechanically robust and easy to preset, so that no further manipulations are required during the production process.

The opening of the pores can be carried out effectively and reproducibly by means of the devices configured according to the invention, the quality and degree of the opening of the pores also being determined by the material behavior of the extrudate. This extrudate must have a basic strength or yield point, which ensures that the open pores produced are not closed again by a merging of the matrix mass. Due to the fact that the pore opening mechanisms (a)-(e) can be superimposed, which is advantageous in accordance with the invention, and the devices according to the invention provided for this purpose, a sufficient pore opening efficiency can also be ensured for critical, soft extrudates.

### Further Inventive Configurations

Further inventive configurations are described in claims 27 to 34.

### Achieving the Object Relating to the Use

This object is achieved by the features of claim 35, which is characterized in that the resulting foamed product with a set degree of pore opening is used as a structured basic element for meat analogs, the proteins used being only of plant origin and such meat analog basic elements being used in menus which bring about a gradual to complete filling of the open pores of the structured basic element through complemented, fluid sauce or juice or dressing or marinade or topping components.

### Further Inventive Configurations

Another advantageous use or configuration is described by the features of claim 36.

### Some Advantages

Fibril-structured meat analogs that can be produced using High Moisture Extrusion Cooking (HMEC) technology based on plant proteins have a compact structure that does not come close enough to the comprehensive sensory requirements of consumers for really comparable texture, taste and some nutritional properties of meat in order to be accepted as a real alternative. The product structures that can be achieved according to the invention with an adjustable ratio of closed and open pores allow the attributes required for meat analogs to be met in that they can be utilized purposefully on the one hand to give a positive texture (tenderness, crispiness) and on the other hand to give taste (juiciness) via the simple absorption capacity of fluid systems. The fundamental non-restriction of the technology package according to the invention to meat analogs also creates a broad implementation horizon for other foamed food systems. Implementations on pharmaceutical and cosmetic products as well as on building/construction materials are also application horizons that can be taken into consideration.

In the drawing, the invention is illustrated, partly schematically, in exemplary fashion.

FIG. 1 shows the adjustable slit-nozzle aperture (VSDA) according to the invention for a flat slit nozzle. The following designations apply in FIG. 1: 1=aperture housing, 2=truncated rotatable, slide-mounted metal cylinder—2a in 0-position with free flow cross-section, 1b turned clockwise, 2c turned counter-clockwise, 3=slit nozzle wall, 4a-4c=aperture inlet flow for the differently rotated metal cylinder settings according to 2a-2c, 5a-5c=aperture outlet flow for the differently rotated metal cylinder settings according to 2a-2c, 6=geometric designations for positioning the metal cylinders, α=angle of rotation of the metal cylinders, β=angle between metal cylinder center and edges of the cutting surface of the metal cylinder.

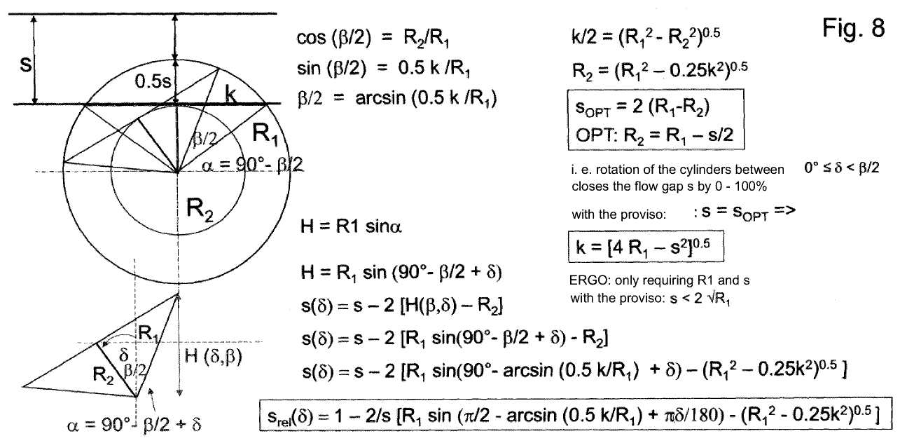

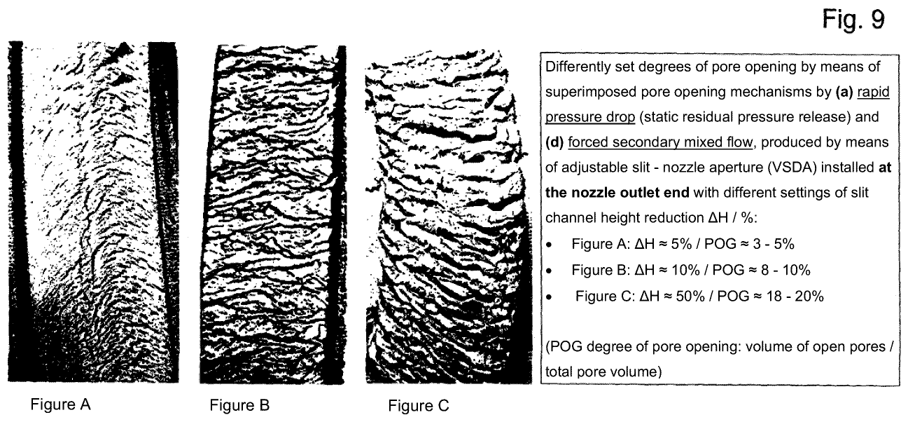

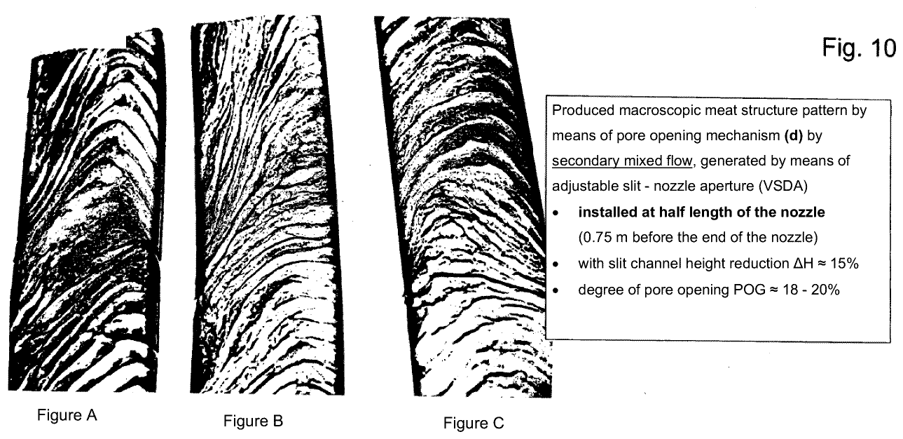

The basis of calculation for the defined reduction in height of the extruder nozzle flat slit channel as a function of the rotation angle δ of the metal cylinders to be set by rotation and as a function of the metal cylinder radius R1 as well as the placement of the cutting surface (angle 3) and the center coordinate R1 of the metal cylinder thus determined are shown in FIG. 8.

In the case of a flat, rectangular extruder nozzle slit channel a truncated, rotatably slide-mounted metal cylinder (2) is sealingly, yet rotatably, embedded in the aperture housing (1) in each case in the upper and lower wall delimiting the flow slit of the aperture device over the entire slit width, at a right angle to the direction of flow. The cutting surfaces of these cylinders are flush with the flow channel wall (3) when the aperture is fully open. The metal cylinders (2) can be set rotatably from outside the aperture housing (1) by hand or by means of two servomotors, so that a constriction of the aperture occurs on one side or symmetrically to the longitudinal axis of the nozzle, which corresponds to the maximum degree of closure of the slit channel at a twist angle of 90°.

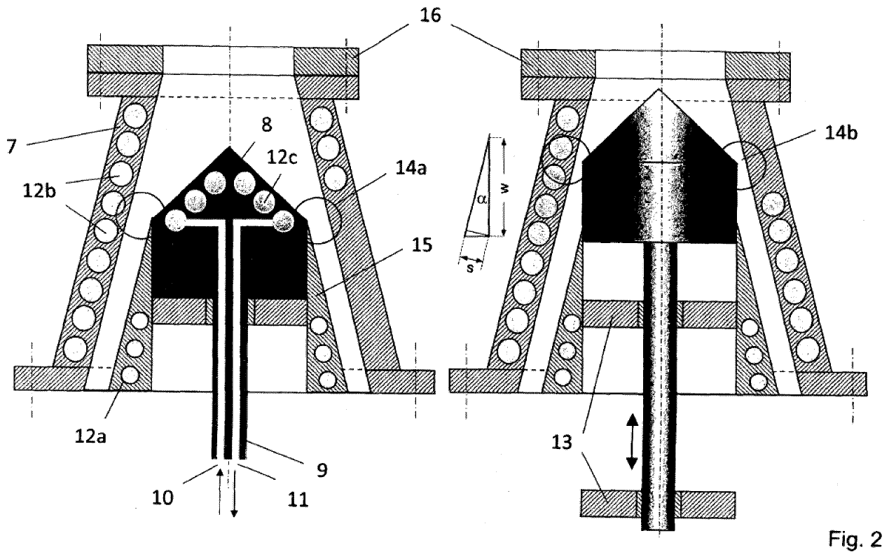

In the case of a ring slit nozzle, which is used for increased extrudate mass flows, the mechanism for adjusting the height of the slit gap is implemented via a concentric, conical design of the inner wall of the nozzle housing and an axially displaceable punch with a conical tip, as shown in FIG. 2.

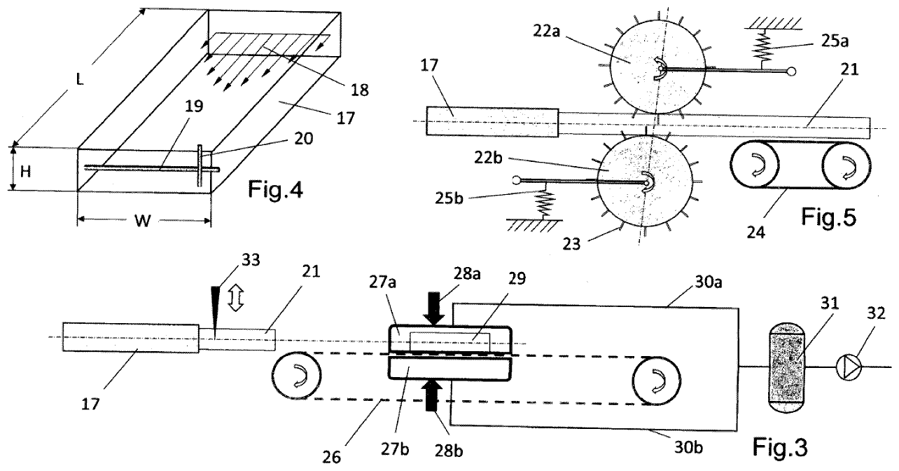

The following designations apply to FIG. 2: 7=conical nozzle housing, 8=axial gap setting punch with conical tip, 9=setting punch guide tube, 10=tempering fluid inlet into setting punch guide tube, 11=tempering fluid outlet from setting punch guide tube, 12=tempering fluid channels in inner (12a) and outer (12b) nozzle housing walls as well as in the setting punch (12c), 13=guides for axial setting punch guide tube, 14=nozzle gap in initial position (14a) and with constricted gap setting (14b), 15=annular slit nozzles inner housing wall part, 16=flange for connecting annular nozzle parts or with extruder housing The device according to the invention as shown in FIG. 3 is used for the additional post-treatment according to the application of the pore opening mechanism (a) for pore opening by means of a rapid drop in ambient pressure (Flash-Opening, FOP) by means of partial vacuum application.

The following applies to the designations in FIG. 3: 17=slit nozzle flow channel, 21=extrudate strand, 26=partially perforated conveyor belt, 27a=upper vacuumizing half-shell, 27b=lower vacuumizing half-shell, 28a=contact pressure pneumatics for upper vacuumizing half-shell, 28b=contact pressure pneumatics for lower vacuumizing half-shell, 29=cut off extrudate part, 30a,b=pipelines for suction (partial vacuum transmission), 31=partial vacuum storage container, 32=vacuum pump, 33=strand cutting device

POT2: The device implemented according to the invention for opening the pores according to mechanism (c) by means of splitting or peeling the product (CUT-Opening, COP) is applied in the exit area of the extruder cooling nozzle by a cutting/paring knife (possibly water jet or laser cutting devices)—arrangement as shown schematically in FIG. 4.

The designations in FIG. 4 are: 17=slit nozzle flow channel, 18=laminar slit nozzle flow, 19=cutting device for positioning above the slit channel height H, cutting device for positioning above the slit channel width W.

POT3: The device for implementing the pore opening according to mechanism (c) for multiple needle penetration (Penetration-Opening, POP) is arranged directly after the extruder nozzle exit and, in the embodiment of the device preferred according to the invention, combines two counter-rotating hollow needle or barbed felting needle rollers, where the needles penetrating the extrudate from both sides engage with each other as shown in FIG. 5.

The designations in FIG. 5 are as follows: 17=slit nozzle flow channel, 22a=upper needle roller, 22b=lower needle roller, 23=penetration needle (hollow needle or barbed felting needle), 24=conveyor belt sub-device, 25a,b=upper, lower penetration needle rollers pressing sub-device (pneumatic/hydraulic/mechanical).

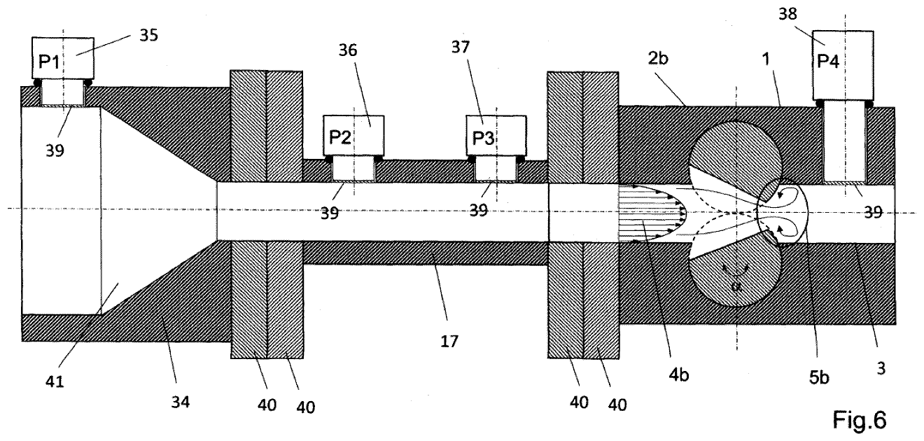

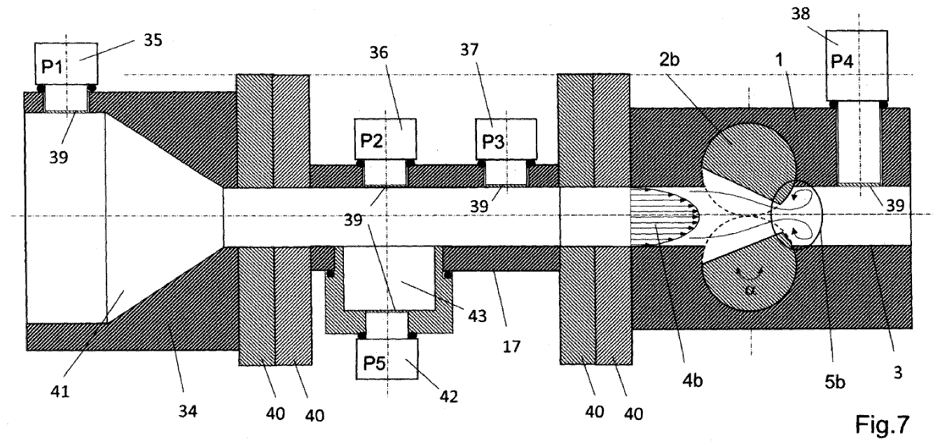

POT-4: The device for implementing the pore opening according to mechanism d) for generating a secondary mixed flow (Mix-Opening, MOP) in the extruder cooling nozzle can, in principle, be limited to the adjustable slot-nozzle aperture (VSDA) device, for in-line control of the intensity of the set secondary mixed flow, however, the coupling with a measuring arrangement according to the invention for determining the static pressure before and after the VSDA device is indicated. This pressure measurement arrangement is shown in combination with the VDSA device in FIGS. 6 and 7.

FIG. 7 includes an expansion of the pressure measurement arrangement from FIG. 6 for the case of viscoelastic fluids, as are present in the case of protein melts for the production of meat analogs.

The designations in FIGS. 6 and 7 are as follows: 1=aperture housing, 2=truncated, rotatable, slide-mounted metal cylinder—2b rotated clockwise, 3=slit nozzle wall, 4b=aperture inlet flow for rotated metal cylinder clockwise (2b), 5b=aperture outlet flow rotated metal cylinder clockwise (2b), 17=slit nozzle flow channel, 35=diaphragm pressure sensor for static pressure measurement P1; 36=membrane pressure sensor for static pressure measurement P2, 37=membrane pressure sensor for static pressure measurement P3, 38=membrane pressure sensor for static pressure measurement P4, 39=pressure sensor membranes, 40=connecting flanges, 41=conical nozzle inlet flow geometry, 42=membrane pressure sensor for static pressure measurement P5, 43=P5—pressure measurement cavity.

For pronounced viscoelastic extrusion fluids, such as those corresponding to foamed protein melts, for example, the aforementioned VSDA is installed according to the invention at a greater distance from the nozzle outlet in the extruder nozzle than in POT-1 technology. In the case of viscoelastic product fluid systems, the aforementioned secondary flows are significantly forced by the effect of elastic turbulence (relaxation of the elastic extra-normal stresses and the resulting reverse deformation of the strand) as a result of adjustable channel cross-section constriction and widening. This effect can be triggered even with a slight constriction of the slit nozzle cross-section and its characteristic can be set and used in a targeted manner to create an open pore structure.

For this purpose, according to the invention, as shown in FIG. 6, static pressure measurements are carried out at a position in the extruder housing before the nozzle inlet cross section (P1) at two longitudinal positions in the extruder slit nozzle (P2, P3) after the nozzle inlet zone (after conical constriction), after the VSDA (P4), and (P5) in the slit nozzle channel before the VSDA, directly opposite (slit nozzle channel underside) to the pressure measurement position P2.

From P2 and P3, the local shear stress Tw on the slit nozzle channel wall and, knowing the product volume flow dV/dt determined at the nozzle outlet, the product shear viscosity η can be determined. Including P1, it is possible to determine a nozzle inlet pressure loss ΔPᵢₙ, which is the sum of (i) a viscous extensional pressure loss ΔP_{D,in} under the effect of the extensional viscosity of the extruded fluid, and (ii) an elastic pressure loss fraction ΔP_{E,in} as a result of elastic energy storage. By means of the additional static pressure measurement P5, a purely elastic parameter fluid response can be determined between the measuring points for P5 and P2 from P5-P2 through reverse deformation as a result of elastic stress relaxation. P2-P5 is proportional to the so-called first normal stress difference N1, which is measured in rheometric laboratory measurements using cone-plate shear gap geometry and can be compared with the values determined in-line or a calibration can be derived therefrom. The elastic component DP_{E,in} of the nozzle inlet pressure loss ΔPᵢₙ can be determined from P2-P5, and thus the complementary viscous expansion component ΔP_{D,in} of ΔPᵢₙ is also obtained. The arrangement according to the invention of the pressure measurement points P1-P3 and P4 thus provides separate rheological parameters for (a) the shear viscosity, (b) the elongational viscosity and (c) the elasticity of the extruded mass under the given extrusion conditions. In the case of the pressure measurement P5, it should be noted that this measurement is not carried out like all other pressure measurements (P1-P4) via a membrane of the pressure sensor flush with the wall in the slit nozzle channel, but at the end of a cavity filled with the extrusion fluid, which has a (narrow) rectangular cross-section (e. g.: with 60 mm nozzle channel width: 10×50 mm) extending in the direction of flow for measuring the first normal stress difference from P2-P5. The pressure measurement P4 occurs at a position in the slit nozzle channel immediately after the constriction created by means of the VSDA device (height reduction of the slit nozzle channel ΔH). In this way, periodic, static pressure fluctuations DP4 (t) generated in particular by a forced secondary mixed flow in the VSDA follow-on are captured. According to the invention, these fluctuations are a measure of the mixing intensity and the associated foam pore opening efficiency according to mechanism (d) identified and described above.

As was surprisingly found in laboratory rheometric measurements for a large number of polymer fluid systems, the “elastic turbulence phenomenon” (also called melt fracture in the plastics industry) shows up in a certain range of the ratio of the first normal stress difference to the shear stress N₁(γ_{w})/τ(γ_{w}) at a wall shear rate g_{w} effective at the slit nozzle channel wall. This range is at 2≤N₁(γ_{w})/τ(γ_{w})<5. The characteristics of the elastic turbulence effect utilized according to the invention for utilizing the mechanism (d) according to the invention of foam pore opening by forced secondary mixed flow preferably occurs in the range 2≤N₁(γ_{w})/τ(γ_{w})<3.5-5. As this ratio value increases, the secondary mixed flow effect is gradually increased. Depending on (i) the rheology of the extruded fluid system (here preferably plant protein-based melt for meat analog production) and the mean flow velocity in the slit nozzle channel, the VSDA device is adjusted with regard to the slit nozzle height reduction in such a way that the intended degree of secondary mixed flow with a correlated pore opening effect is obtained. Thus, by means of substance-system-specific calibration, a quantitative criterion for setting the VSDA slit opening for triggering or setting a gradual characteristic of the forced “elastic-turbulent secondary flow mixing effect” can be determined, which enables the pore opening according to the invention by means of the POT-4 technology and the mechanism (d) triggered thereby in an adjustable manner.

The characteristics of the viscoelastic secondary flow effect used for POT-4 can lead to an almost complete disintegration of the extrudate strand. In plastics technology, this undesirable elastic phenomenon is also referred to as “melt fracture”. For its avoidance, the VSDA device is installed according to the invention >0.2 L_{D} (L_{D}=nozzle length) before the end of the extruder nozzle. As a consequence, the extrudate strand, in the event of partial disintegration, “heals” again in the undisturbed nozzle flow after passing through the VSDA to such an extent that a compact, cohesive, foamed, partially open-pored product strand results without destroying the pore opening effect achieved by elastic-turbulent mixing through repeated flow-related “skin formation”.

Exemplary representations of plant protein-based meat analog product structures and degrees of pore opening according to the invention achieved with the devices according to the invention using the method according to the invention are described below in FIGS. 8-10.

The basic conditions for the examples below are:

HMEC extruder: Co-rotating twin screw BCTL extruder from Bühler AG with a screw diameter of 42 mm and an extruder length to screw diameter ratio of L/D=28.

Extruder cooling nozzle: L=1.85 m, W=60 mm, H=15 mm

Material/basic formulation: 52.5% water, 0.5% oil, 41.2% pea protein isolate (PPI), pea fiber 5.8%

Process conditions: screw speed: 230 rpm; mass flow 37.5 kg/h; nozzle entry temperature of the melt: 150° C.; extruder outlet pressure: 18-20 bar, nozzle cooling temperature: 60° C.

Example 1 (see FIG. 9): Pore opening mechanism by means of (a) sudden residual pressure release and (d) superimposed forced secondary mixed flow.

Different degrees of pore opening were set by means of the superimposed pore opening mechanisms by (a) rapid pressure drop (static residual pressure release) and (d) forced secondary mixed flow, generated by means of the adjustable slit-nozzle aperture (VSDA) installed at the nozzle outlet end with different settings of the slit channel height reduction ΔH/%:
Figure A: ΔH≈5%/resulting degree of pore opening POG≈3-5%
Figure B: ΔH≈10%/resulting degree of pore opening POG≈10-12%
Figure C: ΔH≈50%/resulting degree of pore opening POG≈25-30%

The degree of pore opening (POG) was determined according to:

POG=VOP open pore volume/VGP total pore volume. VOP was determined by placing an extruded sample in water at room temperature (25° C.) for 5 s and, after removing the strand surface, removing free water adhering to it from the surface using household paper in a defined, quick handling procedure by placing it on both sides once on a layer of paper for 1 s each. The differential weighing before and after such treatment resulted in the mass of water sucked into product pores open towards the product surface by capillary forces. VGP was determined by determining the volume and mass of the extruded product, from which the gas volume fraction or overrun (=relative increase in volume due to foaming) was determined relative to the product without foaming.

As can be seen from FIG. 9, the surface of the extrudate shows increasing “fissures” as the height of the VSDA slit nozzle channel increases, as a result of the imposed forced secondary mixed flow with simultaneous residual pressure release. This is a typical image of the resulting product when installing the VSDA at the nozzle end.

The samples considered in this example, untreated with regard to pore opening, had a gas volume fraction after foaming of approx. 25-35% by volume in ≥approx. 98% closed inner foam pores.

Example 2 (see FIG. 10): Pore opening mechanism by means of (d) forced secondary mixed flow, generated by means of an adjustable slit nozzle aperture (VSDA) installed at a nozzle length of 0.75 m from the nozzle outlet when setting the slit channel height reduction DH/%≈15%.

FIG. 10 shows a predominantly smooth extrudate surface with clearly visible flow patterns originating from the forced secondary mixed flow. These patterns “heal” as a result of the subsequent nozzle flow (here over a further 0.75 m of the nozzle length. To a small extent, it reduces the achieved degree of pore opening of the end product, but allows the production of quality-relevant structural patterns according to the invention to a large extent from the consumer's point of view, which reflects a natural distribution of structural inhomogeneities as in meat products (in the example shown: salmon/fish or marbled Wagyu beef structures). The degree of pore opening achieved under the boundary conditions selected in this example is 18-20%.

The samples considered in this example, untreated with regard to pore opening, had a gas volume fraction after foaming of approx. 15% by volume in ≥approx. 98% closed inner foam pores.

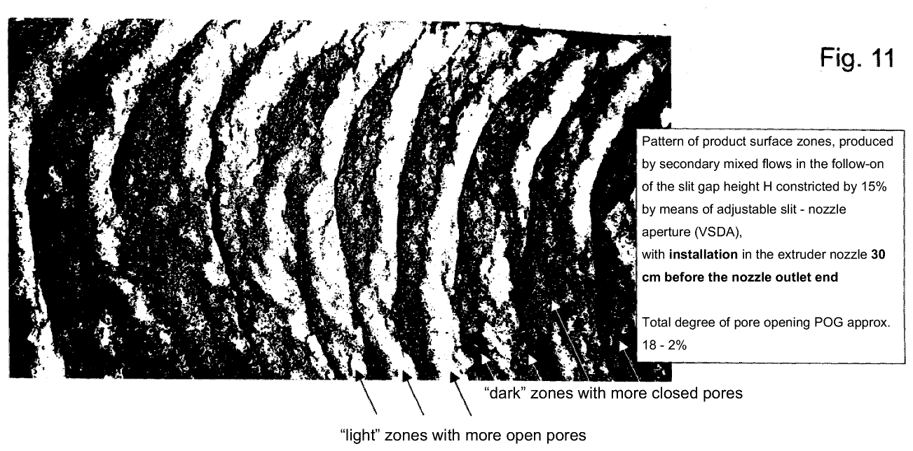

Example 3 (see FIG. 11): Pore opening mechanism by means of (d) forced secondary mixed flows, generated by means of an adjustable slit-nozzle aperture (VSDA) installed at a nozzle length of 0.3 m from the nozzle outlet, when setting the slit channel height reduction DH/%≈15%.

FIG. 11 shows an enlarged image of the product surface. The wavy stripe pattern structures are clearly visible. (H) Lighter (more foamed) and (D) darker (less foamed) areas arranged alternately in strips. The H areas originate from the inner strand foam structure, which is conveyed to the product surface by the forced secondary mixed flow. The D-areas originate from the original “surface-skin layer” depleted of foam pores.

The samples considered in this example, untreated with regard to pore opening, had a gas volume fraction after foaming of approx. 30% by volume in ≥approx. 98% closed inner foam pores. The degree of pore opening (POG) achieved is approx. 18-20%.

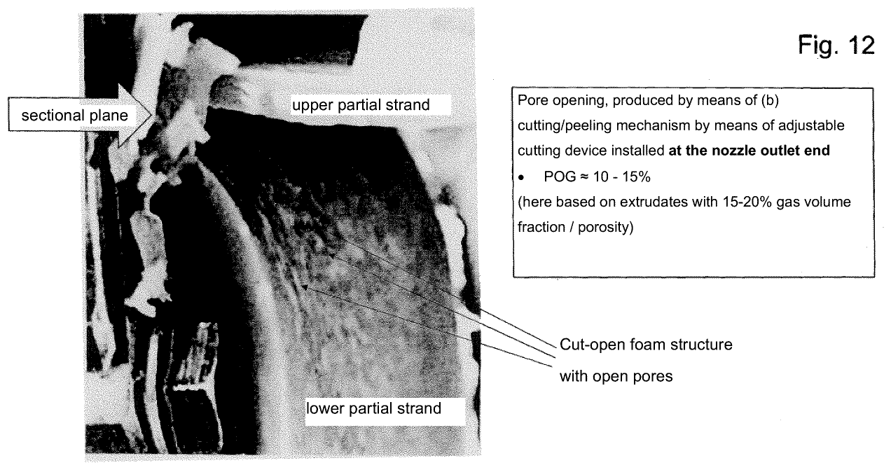

Example 4 (see FIG. 12): Pore opening by means of (b) cutting/peeling mechanism, generated by means of an adjustable cutting device installed at the end of the nozzle outlet.

FIG. 12 shows a foamed, continuously cut strand of extrudate. Open pore structures can be detected on the cutting surface. A degree of pore opening of approx. 10-15% was achieved in the example shown. The extrudates on which this example is based had approx. 15-20% gas volume fraction.

A total volume of open pores of 2-5% is rated as sufficient for enriching the plant protein-based meat analogs described as an example sensorily (aroma, taste) and nutritionally (B vitamins, minerals (Fe, Zn)). To increase product juiciness, ≥10% is relevant, depending on the water fraction of the product matrix.

The features described in the claims and in the description and evident from the drawing can be essential for the implementation of the invention both individually and in any combination.

### LIST OF REFERENCE NUMERALS

1 aperture housing
2 metal cylinder
3 split nozzle wall
4a aperture inlet flow
4b aperture inlet flow
4c aperture inlet flow
5a aperture outlet flow
5c aperture outlet flow
5c aperture outlet flow
6 designations, geometric for the positioning of the metal cylinders
7 nozzle housing, conical
8 gap adjustment punch, axial
9 adjustment punch guide tube
10 tempering fluid inlet
11 tempering fluid outlet
12 tempering fluid channels
12a tempering fluid channels, inner
12b tempering fluid channels, outer
12c tempering fluid channels in the adjustment punch
13 guides
14 nozzle gap
14a nozzle gap in initial position
14b constricted gap setting through the nozzle gap
15 ring slit nozzles
16 flange
17 slot nozzle flow channel
18 laminar slit nozzle flow
19 cutting device
21 extrudate strand
22a needle roller, upper
22b needle roller, lower
23 penetration needle
24 conveyor belt sub-device
25a penetration needle roller pressure sub-device, upper
25b penetration needle roller pressure sub-device, lower
26 conveyor belt, partially perforated
27a vacuumizing half-shell, upper
27b vacuumizing half-shell, lower
28a contact pressure pneumatics, upper
28b contact pressure pneumatics, lower
29 extrudate part, cut off
30a piping for exhaust
30b piping for exhaust
31 partial vacuum storage container
32 vacuum pump
33 strand cutter
34 -
diaphragm pressure transducer
36 diaphragm pressure transducer
37 diaphragm pressure transducer
38 diaphragm pressure transducer
39 pressure transducer membranes
40 connecting flanges
41 nozzle inlet flow geometry, conical
42 diaphragm pressure transducer
α angle of rotation of metal cylinder 2
β angle between the center of the metal cylinder and the edges of the cutting surface of metal cylinder 2
δ angle of rotation of metal cylinder 2
R₁ radius of the metal cylinder
L_{D} nozzle length

### LITERATURE REFERENCES

/1/ V. Lammers1, A. Morant, J. Wemmer, E. Windhab (2017); High-pressure foaming properties of carbon dioxide-saturated emulsions; Rheol Acta (2017) 56:841-850
/2/ E. Windhab, V. Lammers (2017); Patent: Aufgeschäumtes teigbasiertes Lebensmittelprodukt sowie Vorrichtung und Verfahren zur Herstellung des aufgeschäumten teigbasierten Lebensmittelprodukts; Patent Application No. DE 10 2016 111 518 A1
/3/ L. Zeng, F. Najjar, S. Balachandar, P. Fischer (2009); Forces on a finite-sized particle located close to a wall in a linear shear flow; Physics of Fluids 21, 033302, 2009
/4/ D. Legendre, J. Magnaudet (1998); The lift force on a spherical bubble in a viscous linear shear flow; J Fluid Mech. (1998), Vol. 368, pp. 81±126. #1998 Cambridge University Press
/5/ P. J. Fellows (2016); Food Processing Technology: Principles and Practice; Woodhead Publishing Series in Food Science, Technology & Nutrition; Woodhead Publishing, 2016; ISBN 0081005237, 9780081005231
/6/ P. J. Hailing & P. Walstra (1981) Protein-stabilized foams and emulsions, C R C Critical Reviews in Food Sci. & Nutrition, 15:2, 155203, DOI: 10.1080/1040839810952 7315
/7/ Ashley J. Wilson (1989) Foams: Physics, Chemistry and Structure; Springer-Verlag London, ISBN 978-1-4471-3809-9.
/8/ N. Mills (2007); Polymer Foams Handbook; Hardcover ISBN: 9780750680 691; Imprint: Butterworth-Heinemann).
/9/ U.S. Pat. No. 6,635,301 B1
/10/ WO2016/150834 A1
/11/ EP1182937 A4
/12/ WO2009075135
/13/ US20050003071 A1
/14/ WO2016150834 A1
/15/ U.S. Pat. No. 10,716,319 B2
/16/ WO 2017/081271 A1
/17/ KR 1020200140499 A
/18/ US 2020/0060310 A1

1.-36. (canceled)

37. A foamed, resilient, protein-based product with a dry matter fraction of 20-60% by weight, a bound water fraction of ≥40% by weight and a gas pore structure, with a set (i) ratio of gas-filled pores open towards the product surface (OP) to gas-filled pores enclosed in the product volume (GP) in the range of 0.05-0.95, for values of this ratio of >0.1 with an accuracy of ±0.05, and (ii) gas volume fraction between 0.1 and 0.8 with an accuracy of 0.05.

38. The product according to claim 37, wherein the product has a protein fraction of 10-95% by weight in its dry matter.

39. The product according to claim 37, wherein the protein fraction consists of 0-100% by weight plant protein.

40. The product according to claim 37, wherein the protein in the product is present in a partially to fully denatured form and has a fibrillar structure.

41. The product according to claim 40, wherein the denatured form has an oriented fibrillar structure.

42. The product according to claim 37, wherein the product includes a plant fiber fraction of 0.5-20% by weight, based on the dry matter.

43. The product according to claim 37, wherein the product includes a fraction of fats or oils of 0.1-15% by weight, based on the dry matter.

44. The product according to claim 37, wherein the product includes a fraction of flavoring and/or coloring components and/or components which increase the nutritional value in addition to the plant fiber fraction of 0.1-5% by weight, based on the dry matter.

45. The product according to claim 37, wherein the product, after drying to a residual water content of ≤50% by weight and moisture-controlled storage for several months with no spoilage under room temperature conditions, upon contacting with water or a water-containing fluid system reconstitutes to its original volume and texture without loss of dry matter.

46. The product according to claim 37, wherein the product, after drying to a residual water content of ≤50% by weight and moisture-controlled storage for several months with no spoilage under room temperature conditions, upon contacting with water or a water-containing fluid system reconstitutes to its original volume and texture.

47. A method for producing a product according to claim 37, wherein the method implements the opening of gas pores or gas bubbles enclosed in the foamed product towards the product surface at gas volume fractions of 0.1-0.8, preferably 0.1-0.5 with a setting accuracy with regard to the ratio of the volumes of pores open towards the product surface to closed pores of ±0.05 in the range of this ratio of 0.1-0.9, based on an extrusion method of the “high moisture extrusion cooking” type (High Moisture Extrusion Cooking, HMEC) with gas entry, temporary gas dissolution and controlled gas bubble nucleation as well as foam formation, and five method variants for pore opening being employed: (a) opening by rapid ambient pressure drop (Flash-Opening, FOP), (b) opening by splitting or peeling the product (Cut-Opening, COP), (c) opening by multiple needle penetration (Penetration-Opening, POP), (d) opening by forced secondary mixed flow (Mix-Opening, MOP) and (e) opening by freeze structuring (Freeze-Opening, FROP), individually or in combination.

48. The method according to claim 47, wherein the opening of closed pores towards the product surface occurs by means of the opening mechanisms (c) by multiple needle penetration (Penetration Opening, POP) and (e) by freeze structuring after the exit of the partially cooled product from the extruder cooling nozzle, by means the opening mechanisms (a) by rapid drop in ambient pressure (Flash-Opening, FOP) and (b) by splitting or peeling the product (CUT-Opening, COP) in the exit area of the extruder cooling nozzle, and the opening mechanism (d) by forced secondary mixed flow (Mix-Opening, MOP) in the extruder cooling nozzle.

49. The method according to claim 47, wherein the opening of closed pores towards the product surface by means of (a) rapid ambient pressure drop (Flash-Opening, FOP) is set by maintaining the static pressure until just before the nozzle exit at a pressure level of ≥2 bar by means of an adjustable slit-nozzle aperture (VSDA), which is installed at the extruder nozzle outlet or just (≤10 cm) before it, depending on the viscosity of the exiting fluid mass, to a static pressure prevailing before the VSDA in such a way that there is the opening of inner pores towards the product surface for a likewise product-specifically set fraction of the pores open towards the product surface, based on the total number of closed and open pores.

50. The method according to claim 47, wherein the opening of closed pores towards the product surface occurs by means of (a) pore opening by rapid ambient pressure drop (Flash-Opening, FOP) by suddenly applying a partial vacuum of ≤100 mbar for an extrudate strand section after it has been cut off in a quasi-continuously operating vacuum chamber device.

51. The method according to claim 47, wherein the opening of closed pores towards the product surface occurs by means of (b) splitting or peeling the product (CUT-Opening, COP) by continuously cutting the extrudate strand using a cutting device installed at the end of the extruder slit nozzle, or peeling off its surface layers.

52. The method according to claim 47, wherein the opening of closed pores towards the product surface occurs by means of (c) multiple needle penetration (Penetration-Opening, POP), thereby generating connecting channels with diameters of 0.1-2 mm between inner closed pores or bubbles and the product surface.

53. The method according to claim 47, wherein the opening of closed pores towards the product surface occurs by means of the mechanism according to the invention of (d) forced secondary mixed flow (Mix-Opening, MOP), generating, by local cross-sectional constriction of the extruder slit nozzle by means of an adjustable slit-nozzle aperture (VSDA) built into the extruder cooling nozzle via an adjustable slit gap height reduction made with it in the follow-on of the constriction produced, a roller-shaped secondary flow, which is also adjustable in terms of its intensity and associated mixing efficiency in the direction of the slit height extension of the nozzle gap, with alignment of the roller flow rotation axes across the nozzle slit width transverse to the main flow direction.

54. The method according to claim 47, wherein the opening of closed pores towards the product surface occurs by means of the mechanism according to the invention of (d) forced secondary mixed flow (Mix-Opening, MOP), generating for viscoelastic protein melts and other viscoelastic fluid systems, by local cross-sectional constriction of the extruder slit nozzle by means of an adjustable slit-nozzle aperture (VSDA) built into it in the follow-on of constriction produced by slit nozzle height reduction, a roller-shaped, periodically fluctuating secondary flow, which is also adjustable in terms of its intensity and associated mixing efficiency in the direction of the slit height extension of the nozzle gap, with alignment of the roller flow rotation axes across the nozzle slit width transverse to the main flow direction, and by means of an inventive in-line measurement of the amplitude of the sinusoidally oscillating temporal, static pressure profile before or after the VSDA, the degree of intensity of the secondary flow mixing effect is described quantitatively and is set gradually by adjusting the nozzle slit gap width within the VSDA device.

55. The method according to claim 47, wherein the gap constriction occurs by adjusting the slit height by means of the adjustable slit-nozzle aperture (VSDA) according to the invention in accordance with viscous and resilient material parameters of the extruded fluid mass under extrusion conditions that are measured rheometrically in-line or off-line in a cone-plate-shearing gap, with the viscous properties being described by the shear stress τ as a function of the shear rate γ, the resilient properties being described by the first normal stress difference N1 as a function of the shear rate γ and the gap constriction of the slit nozzle is carried out in such a way that for the ratio N1/τ at the apparent wall shear rate ysw prevailing in the slit nozzle gap, the relation 2≤(N1/τ)<5 holds.

56. The method according to claim 47, wherein the in-line measurement of the static pressure profile before or after the VSDA in a simplified manner only takes into account the amplitude of the oscillatory fluctuations in the static pressure as proviso for setting the constriction of the slit gap, the secondary flow mixing effect thus generated in the aperture follow-on flow, and the associated opening of inner closed foam pores towards the slit nozzle wall and thus towards the extrudate surface, and the generation of new pore channels or gaps open to the product surface.

57. The method according to claim 47, wherein the opening of closed pores towards the product surface occurs by means of (e) freeze structuring, with rapid cooling of the product occurring after the extrusion nozzle exit and cooling post-treatment is carried out in the temperature range between −1 and −20° C., preferably with periodic temperature control, within these limits.

58. The method according to claim 47, wherein the product, after partial pore opening has taken place, is gently dried to a residual water fraction which allows moisture-controlled product storage at room temperature for several months without microbiological or enzymatic spoilage phenomena occurring.

59. The method according to claim 47, wherein the product is reconstituted by water or fluid absorption after partial opening of the pores and gentle drying to a residual water fraction which allows moisture-controlled product storage at room temperature conditions for several months.

60. A device for carrying out the method according to claim 47, wherein integrated into the temperature-controlled extruder nozzle channel (i) a cutting device and/or (ii) an adjustable slot-nozzle aperture (VSDA) are integrated, and/or downstream the extruder nozzle (iii) a flash vacuum device and/or (iv) a fluid infusion device and/or (v) a cooling/freezing device are arranged downstream, and these devices are coupled with suitably adapted measuring sensors/measuring techniques which measure the set degree of exposure by means of the devices (i)-(v) for opening a specific fraction of the foam pores.

61. The device according to claim 60, wherein the extrusion nozzle has a downstream cutting device and a downstream conveyor belt partially perforated in the middle in sections of the cooling nozzle of an HMEC foaming extruder, and the conveyor belt with the cut-off part of the product lying on top is guided between two vacuumizing half-shells which, pressing against each other from above and below, enclose the conveyor belt and the product in a sealed manner, and wherein these vacuumizing half-shells are connected to a vacuum storage tank via a vacuum line provided with a quick opening valve and which vacuum storage tank is connected to a vacuum pump, for the sudden application of a partial vacuum to the foamed, extruded product.

62. The device according to claim 61, wherein in the extruder nozzle outlet, embedded in the slit nozzle channel to ensure product strand guidance, cutting knives with a small blade width of ≤2 mm or thin cutting wires or water jet or laser cutting devices are arranged in such a way that either (i) cutting or peeling off the surface layers with a layer thickness of ≤1 mm occurs or (ii) the product strand is split in the middle in the slit height direction.

63. The device according to claim 61, wherein two rotatably suspended needle rollers equipped with solid needles with barbed felting needle or hollow needles with needle diameters between 0.3-5 mm are arranged at the nozzle outlet, between which the extruded product formed strip-like as an extrudate strand is guided and the needle penetration depth is set between 1-20 mm depending on the product shape and the puncture number density is set between 1-49/cm2.

64. The device according to claim 61, wherein a slit-nozzle aperture (VSDA) adjustable in the gap width between 10-100% of the slit channel height of the extrusion nozzle in case (A) of purely viscous flow properties of the non-solidified or partially solidified fluid system is arranged between 10-50% of the nozzle length before the nozzle end of the cooled extruder slit nozzle, and in case (B) of viscoelastic flow properties of the non-solidified or partially solidified fluid system is arranged between 5-95% of the nozzle length before the nozzle end of the cooled extruder slit nozzle or directly at the nozzle end.

65. The device according to claim 61, wherein the slit-nozzle aperture (VSDA), which can be adjusted in the gap width between 10-100% of the slit channel height of the extrusion nozzle, in its 100% open state corresponds exactly to the dimensions of the free extruder slit nozzle cross-section, and in the case of an existing flat, rectangular extruder nozzle slit channel a truncated, rotatably slide-mounted metal cylinder is sealingly embedded in each case in the upper and lower wall delimiting the flow slit of the aperture device over the entire slit width, at a right angle to the direction of flow, with the cutting surfaces of these cylinders being flush with the flow channel wall when the aperture is fully open, and, when the cylinders are rotated externally by hand or by means of a servomotor, an adjustable constriction of the aperture occurs on one side or symmetrically to the longitudinal axis of the nozzle, which corresponds to the maximum degree of closure of the slit channel at a twist angle of 90°.

66. The device according to claim 61, wherein the slit-nozzle aperture (VSDA) inserted, which can be adjusted in the gap width between 10-100% of the slit channel height of the extrusion nozzle, in its 100% open state exactly corresponds to the dimensions of the free extruder-slit nozzle cross-section and, in the case of an extruder nozzle with an annular gap for higher throughput rates, a piston-like punch with a conical attachment is arranged to constrict the annular slit gap in such a way that its defined axial insertion, preferably by means of a servomotor, into the extruder outlet nozzle which is conically designed for adapting the extruder annular slit nozzle, defines a defined constriction of the annular slit gap.

67. The device according to claim 61, wherein the extruder cooling nozzle and the extruder nozzle inlet are equipped according to the invention with 4-5 sensors (P1-P4, P5) for static pressure measurement, with one of the sensors (P1) preferably being arranged flush with the wall before the extruder nozzle inlet and three of the sensors (P2-P4) being arranged in the extruder slit nozzle, of which two (P2, P3) are arranged flush with the wall before the slit channel constriction set by means of the VSAD, and one (P4) is arranged also flush with the wall directly in the outlet flow of this slit channel constriction, and in the case of viscoelastic fluid properties an additional fifth sensor for static pressure measurement (P5) is placed directly opposite sensor P2 on the opposite side of the slit channel, but not flush with the wall, but in a cavity inserted in the bottom of the slit channel nozzle, and wherein this cavity forms a cuboid bulge of the slit nozzle with a rectangular cross-section, preferably in the dimension ranges (1-1.5)×(4-6) cm, and has a depth of 3-6 cm.

68. The device according to claim 61, wherein the sensors for static pressure measurement P1 to P3 are integrated flush with the wall in the flat slit flow channel for the in-line detection of apparent extensional and shear viscosities in the nozzle inlet flow, and the sensors for static pressure measurement P2 and P5 are installed in the flow channel height direction orthogonal to the flow direction and directly opposite each other, P2 flush with the wall in the flow channel, P5 not flush with the wall, but on the bottom of a cavity with a rectangular cross-section, to determine a pressure differential proportional to an elastic normal stress differential, and the sensor P4 is integrated in the flow channel, flush with the wall and in flow direction after the adjustable slit-nozzle aperture (VSDA), for measuring the oscillatory pressure fluctuations caused by the secondary flow.

69. The device according to claim 61, wherein the extruder nozzle outlet is connected to a cooling immersion bath for cooling the extrudate strand to below −20° C., preferably to below −50° C., and, according to the invention, two freezing chambers are connected downstream for periodic—1-2 h period duration—product rearrangement, these freezing chambers being set to constant −1° C. and −20° C.

70. Use of the product according to claim 61, wherein the resulting foamed product with a set (i) degree of pore opening in the range of 0.1-0.9 and (ii) gas volume fraction between 0.1 and 0.8 with setting accuracy of ±0.05 in each case is used as a structured basic element for meat analogs, the proteins used being only of plant origin and such meat analog basic elements being used in menus which bring about a gradual to complete filling of the open pores of the structured basic element through complemented, fluid sauce or juice or dressing or marinade or topping components.

71. Use according to claim 70, wherein the product is used as a component in cheese, candy, baked goods, waffles and chocolate confectionery.
